(19) United States
(12) Patent Application Publication
(10) Pub. No.: US 2016/0063583 A1
(43) Pub. Date: Mar. 3, 2016

(54) SHIPPING ALLIANCE

(71) Applicants: Praveen Nuthulapati, Austin, TX (US); Jayasree Mekala, Austin, TX (US); Krishna Sai Pendela Bala Venkata, Austin, TX (US); Kamal Zamer, Austin, TX (US)

(72) Inventors: Praveen Nuthulapati, Austin, TX (US); Jayasree Mekala, Austin, TX (US); Krishna Sai Pendela Bala Venkata, Austin, TX (US); Kamal Zamer, Austin, TX (US)

(21) Appl. No.: 14/473,482

(22) Filed: Aug. 29, 2014

(51) Int. Cl. G06Q 30/06; G06Q 10/08

(52) U.S. Cl. CPC G06Q 30/0605; G06Q 10/083

(57) ABSTRACT

A system and method for a shipping alliance application are described. The system accesses orders from an online marketplace application. A group of buyers based on unfulfilled orders of buyers within a buyer predefined distance of each other is identified. A group of sellers based on unfulfilled orders of sellers within a seller predefined distance of each other is identified. A buyer local entity associated with the group of buyers is identified. A seller local entity associated with the group of sellers is identified. The system generates a request to a common seller of the group buyers to combine items from the unfulfilled orders into a single flat fee shipment to the buyer local entity, or a request to group of buyers to ship items from the unfulfilled orders to the seller local entity.

### TECHNICAL FIELD

This application relates generally to the field of computer technology and, in a specific example embodiment, to a method and system for forming shipping alliances among local buyers and local sellers in a marketplace.

### BACKGROUND

Online and offline marketplaces include many sellers listing items for sale. Buyers buy these items, and sellers ship the items to the buyer upon receipt of payment. Many buyers and sellers are located across the country or across many geographical regions. Shipping cost increases with the number of items being shipped separately to multiple shipping destinations, further contributing to cardboard and fuel waste.

### BRIEF DESCRIPTION OF THE DRAWINGS

The present disclosure is illustrated by way of example, and not by way of limitation, in the figures of the accompanying drawings in which:

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a shipping alliance application.

FIG. 4A shows a map diagram illustrating one example embodiment of an operation of the shipping alliance application for multiple buyers in local proximity to each other.

FIG. 4B shows a map diagram illustrating one example embodiment of an operation of the shipping alliance application for multiple sellers in local proximity to each other.

FIG. 4C shows a map diagram illustrating one example embodiment of an operation of the shipping alliance application for multiple sellers in local proximity to each other and for multiple buyers in local proximity to each other.

FIG. 5 shows a flow diagram illustrating one example embodiment of an operation of the shipping alliance application for multiple buyers in local proximity to each other.

FIG. 6 shows a flow diagram illustrating one example embodiment of an operation of the shipping alliance application for multiple sellers in local proximity to each other.

FIG. 7 shows a flow diagram illustrating one example embodiment of an operation of the shipping alliance application for multiple sellers in local proximity to each other and for multiple buyers in local proximity to each other.

FIG. 8 shows a flow diagram illustrating one example embodiment of an operation of the shipping alliance application for predictive shipping.

FIG. 9A shows an interaction diagram illustrating one example embodiment of an operation of the shipping alliance application for multiple buyers in local proximity to each other.

FIG. 9B shows an interaction diagram illustrating one example embodiment of an operation of the shipping alliance application multiple sellers in local proximity to each other.

FIG. 9C shows an interaction diagram illustrating one example embodiment of an operation of the shipping alliance application for multiple sellers in local proximity to each other and for multiple buyers in local proximity to each other.

FIG. 10 shows a diagrammatic representation of machine, in the example form of a computer system, within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for providing operations of a shipping alliance application are described. The system accesses orders from an online marketplace application. A group of buyers based on unfulfilled orders (e.g., not yet shipped) of buyers within a buyer predefined distance of each other is identified. A group of sellers based on unfulfilled orders of sellers within a seller predefined distance of each other is identified. A buyer local entity associated with the group of buyers is identified. A seller local entity associated with the group of sellers is identified. The system generates a request to a common seller of the group of buyers to combine items from the unfulfilled orders into a single flat fee shipment to the buyer local entity, or a request to the group of buyers to ship items from the unfulfilled orders to the seller local entity.

In one example embodiment, the buyer local entity includes a third party, a buyer from the group of buyers, or a shipping carrier. Similarly, the seller local entity includes a third party, a seller from the group of sellers, or a shipping carrier. The buyers from the group of buyers have a corresponding shipping delivery address in proximity of each other. The sellers from the group of sellers have a corresponding shipping originating address in proximity of each other.

In another example embodiment, a new buyer local entity associated with the group of buyers is formed in response to determining that the group of buyers is not associated with any buyer local entity.

In another example embodiment, a new seller local entity associated with the group of sellers is formed in response to determining that the group of sellers is not associated with any seller local entity.

In another example embodiment, the shipping alliance application generates a local delivery request to the buyer local entity to deliver items from the unfulfilled orders to the corresponding buyers associated with the buyer local entity.

In another example embodiment, the shipping alliance application computes a shipping delivery fee for each buyer based on a fee associated with the single flat fee shipment.

In another example embodiment, the shipping alliance application accesses historical order data from the online marketplace application, identifies historical orders for an item from a second group of buyers with shipping delivery addresses within a geographic range and from a second seller, identifies a buyer local entity associated with the second group of buyers, and generates a request to the second seller to ship additional items to the buyer local entity based on the historical orders for the item.

### System Architecture

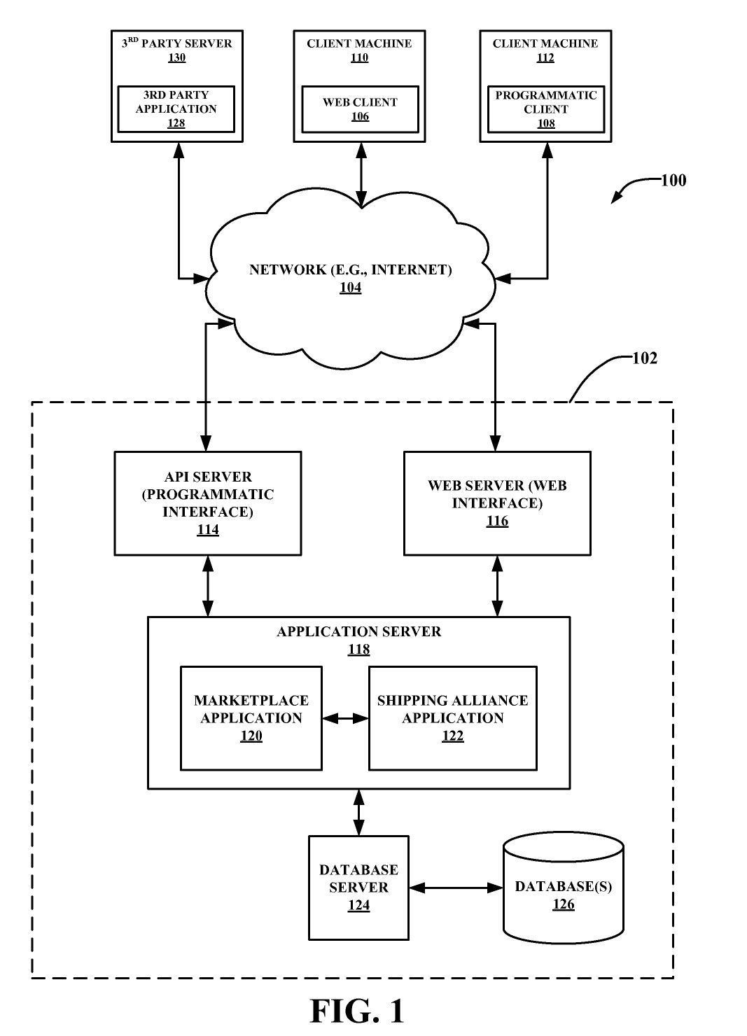

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a shipping alliance application 122, may provide server-side functionality, via a network 104 (e.g., the Internet) to one or more clients. The one or more clients may include users that utilize the network system 100 and, more specifically, the marketplace application 120 and the shipping alliance application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112 or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the shipping alliance application 122, an application program interface (API) server 114 and the web server 116 are coupled to, and provide programmatic and web interfaces respectively to, one or more application servers 118. The application server 118 hosts one or more marketplace applications 120 and shipping alliance applications 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods or services (e.g., for sale) published on the marketplace application 120.

In one embodiment, the shipping alliance application 122 includes a system and a method for optimizing shipment of items between buyers and sellers by forming local alliances in the form of local entities. For example, a group of buyers located within a few miles of each other may form a group associated with a buyer local entity (LEB). If the group of buyers orders from the same seller, the seller is instructed to combine and send the items ordered by the group of buyers in a single shipment to the LEB, thereby saving money by avoiding multiple shipments. Similarly, a group of sellers located within a few miles of each other may form a group associated with a seller local entity (LES). If a buyer orders items from the group of sellers in the LES, the sellers in the LES are instructed to send the items to the LES where the LES combines the items into one shipment to the buyer, thereby saving money by avoiding multiple shipments.

For example, the LES or LEB may include warehouses or fulfillment centers with physical facilities located throughout one or more countries configured to hold inventory for sellers or buyers. In other words, a seller may ship an item for sale on the marketplace application 120 to a LES or LEB depending on the orders in the marketplace application 120. Once the item is sold using the marketplace application 120, the order is fulfilled by shipping items from the seller in one bundled package or shipment to the LEB where the items are delivered locally to each buyer on their “last mile.” The bundled package may take advantage of flat rate shipping. Furthermore, additional data may be mined from the historical data of the marketplace application 120 for predictive purposes to determine item order trends (e.g., what items are likely to be ordered from which seller and which buyer). Further, historical data mined may include item descriptions, dimensions, weights, shipping services most often used or associated with, cost of service, and estimated delivery time.

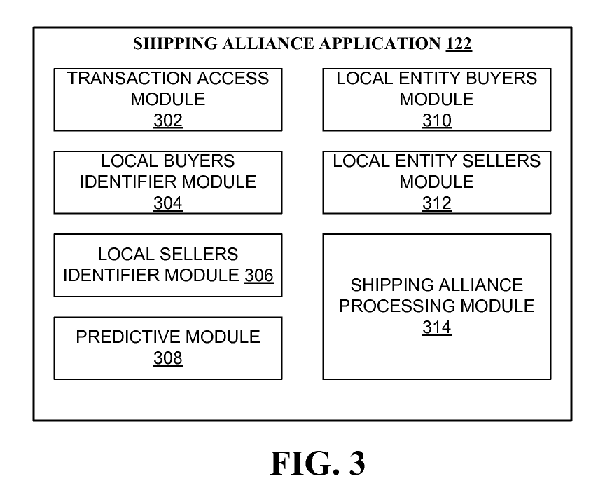

The shipping alliance application 122 can consolidate shipment of items from one LES to an LEB so that the shipping cost per package can be reduced as a result of the consolidation or combining shipments into a single shipment. The single shipment may include, for example, a pallet or a carton that can house multiple smaller shipments, packages, or items. If the shipment of the item viewed by a potential buyer can be consolidated in a container, the shipping alliance application 122 can offer the user a shipping discount valid for a limited time. The shipping alliance application 122 is described in more detail below with respect to FIG. 3. In one embodiment, the functions and operations of the shipping alliance application 122 may be incorporated into the marketplace application 120.

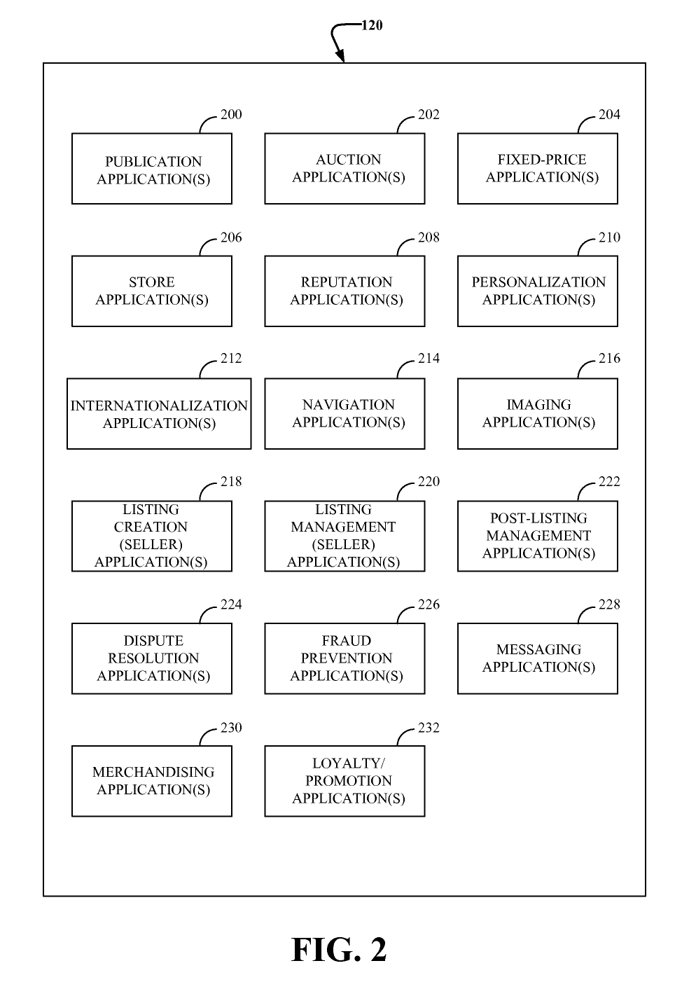

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the shipping alliance application 122 themselves are communicatively coupled (e.g., via appropriate interfaces) to each other and to various data sources, so as to allow information to be passed between the marketplace application 120 and the shipping alliance application 122 or so as to allow the marketplace application 120 and the shipping alliance application 122 to share and access common data. The marketplace application 120 and the shipping alliance application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the shipping alliance application 122. The shipping alliance application 122 may include a transaction access module 302, a local buyers identifier module 304, a local sellers identifier module 306, a predictive module 308, a local entity buyers module 310, a local entity sellers module 312, and a shipping alliance processing module 314.

The transaction access module 302 retrieves orders from the marketplace application 120 or from database 128. In one example, the transaction access module 302 retrieves unfulfilled orders where ordered items have not yet been shipped or have not yet been fulfilled.

The local buyers identifier module 304 identifies buyers that are in proximity to one another. For example, the local buyers identifier module 304 parses the pending orders retrieved by the transaction access module 302 to identify buyers from a same zip code. In another example, the local buyers identifier module 304 parses the pending orders to identify buyers with a shipping delivery address within a radius of a predetermined number of miles or within a predefined geographic zone. The local buyers identifier module 304 identifies an address associated with the buyer. The address may include the delivery address of where the buyer would like the item shipped. For example, the buyer may identify several addresses in the marketplace application 120 for delivery addresses (e.g., home, work, vacation home). The buyer may also identify a default shipping address. The buyer may include a user who views an item for sale using the marketplace application 120. The term “buyer” may also refer to a user who has purchased or not yet purchased the item in the marketplace application 120. For example, the user may be referred to as a buyer when the user views items for sale without placing a purchase order, places any item for sale in a virtual shopping cart or wish list, or submits an order for any item for sale. The local buyers identifier module 304 communicates with the marketplace application 120 to access address information of the buyer. In another embodiment, the local buyers identifier module 304 identifies a buyer geographic region associated with a shipping or delivery address of the buyer. For example, the local buyers identifier module 304 identifies a county or a zip code associated with the delivery address of the buyer. The local buyer identifier module 304 may also identify buyers that are ordering from a same seller.

The local sellers identifier module 306 identifies sellers that are in proximity to one another. For example, the local sellers identifier module 306 parses the pending orders retrieved by the transaction access module 302 to identify sellers having a same zip code. The local sellers identifier module 306 may also identify sellers shipping to a same buyer. In another example, the local sellers identifier module 304 parses the pending orders to identify sellers with a shipping originating address within a radius of a predetermined number of miles or within a predefined geographic zone. The seller may include a user who listed an item for sale using the marketplace application 120. The term “seller” may also refer to a user who has sold or not yet sold a listed item for sale in the marketplace application 120. The seller location identifier 302 communicates with the marketplace application 120 to access address information of the seller.

The local entity buyers module 310 identifies a LEB associated with the group of local buyers that was previously identified using the local buyers identifier module 304. If an LEB is not already associated with the group of local buyers, the local entity buyers module 310 may form a new LEB associated with the group of local buyers. For example, a request may be generated to the group of local buyers to identify and select one of the buyer or a third party as a new LEB.

The local entity sellers module 312 identifies a LES associated with the group of local sellers that was previously identified using the local sellers identifier module 306. If an LES is not already associated with the group of local sellers, the local entity sellers module 312 may form a new LES associated with the group of local sellers. For example, a request may be generated to the group of local sellers to identify and select one of the seller or a third party as a new LES.

In one embodiment, the shipping alliance processing module 314 instructs a seller to combine orders from different buyers local to each other, in one package to take advantage of flat rate shipping. Flat rate shipping allows a sender to send a package with predefined dimensions for a flat rate. As such, the shipping rate is the same whether one or several items can fit in the package or shipping box. The seller is thus instructed to ship to an LEB associated with buyers local to each other. The LEB can then distribute the items locally to each buyer pursuant to the respective marketplace orders. In another example, the buyers can pick up their items at the LEB.

In another example embodiment, the shipping alliance processing module 314 instructs sellers (local to each other) of items ordered by a single buyer to ship the items to a LES to take advantage of flat rate shipping. The LES ships the items in one shipment to the single buyer. In another example, the sellers can drop off their items at the LES.

In another example embodiment, the shipping alliance processing module 314 may instruct a LES to ship a single shipment to a LEB. As such, a plurality of seller in proximity to each other can consolidate items into a single shipment to a plurality of buyers also in proximity to each other.

The shipping alliance processing module 314 computes a shipping discount offer based on the savings from the flat rate shipping. For example, the discount offer may be a flat discount rate such as 10% off standard shipping, or may dynamically vary based on space availability of the flat rate shipping. For example, if there are a lot of spaces available, the shipping alliance processing module 314 may increase the shipping discount rate to incentivize the buyer to purchase the item.

The shipping alliance processing module 314 or the marketplace application 120 generates a notification to the buyer of the shipping discount offer valid for a limited amount of time after the buyer views the item in the online marketplace. For example, the message to the buyer may include “order within the next 2 hours and get 10% off your shipping cost and the item ships today.” The limited amount of time may be based on a cut off shipping time of a prescheduled shipping route for the container. For example, if the buyer views the item at 3 pm and the cutoff time is 4:30 pm for the 5 pm shipment, the limited amount of time may be 1.5 hours.

In another embodiment, the limited amount of time may be computed based on the space availability of the container. For example, if there are a lot of spaces left in the container, the limited amount of time may be longer than if the container has very little available space left.

The shipping alliance processing module 314 monitors space in the container and allocates a compartment space in the container if the buyer chooses to order with the shipping discount within the allotted limited amount of time. As such, after the order is placed from the buyer, the space availability of the container decreases according to the size of the item. The size of the item may be determined from a lookup table based on historical transactions in the marketplace application 120 or provided by the seller.

Once the container is received at the corresponding LEB, all individual orders would be shipped out to the last mile buyer location. By consolidated shipping in the middle “mile,” i.e., between sellers or LES and buyers or LEB, the shipping cost per package could be optimized (discounted) as a result of the consolidation or combining of shipments in a pallet/carton. Without consolidation, the shipping costs for each package would have no discount applied (e.g., standard shipping carrier charges).

The predictive module 308 may access historical data of the marketplace application 120 to determine that a seller typically sells items to a particular region. The predictive module 308 may compute and estimate how many more items to ship to a same region prior to receiving an order for the item from the same region, thereby saving shipping costs. The predictive module 308 may request the seller to ship additional items in addition to a currently fulfilled order to a LEB to anticipate future orders for the same items from the sellers from buyers associated with the LEB.

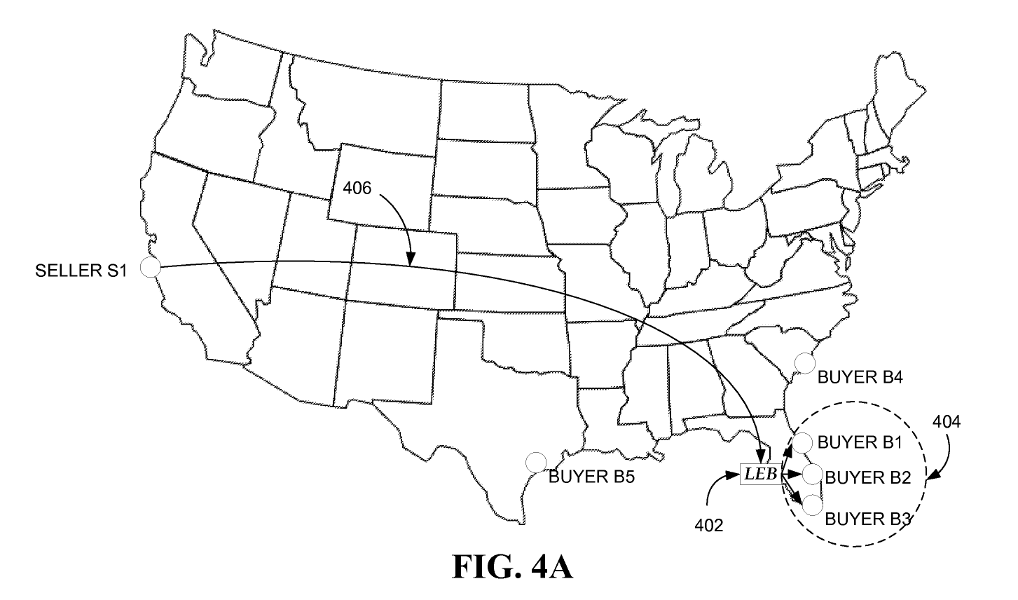

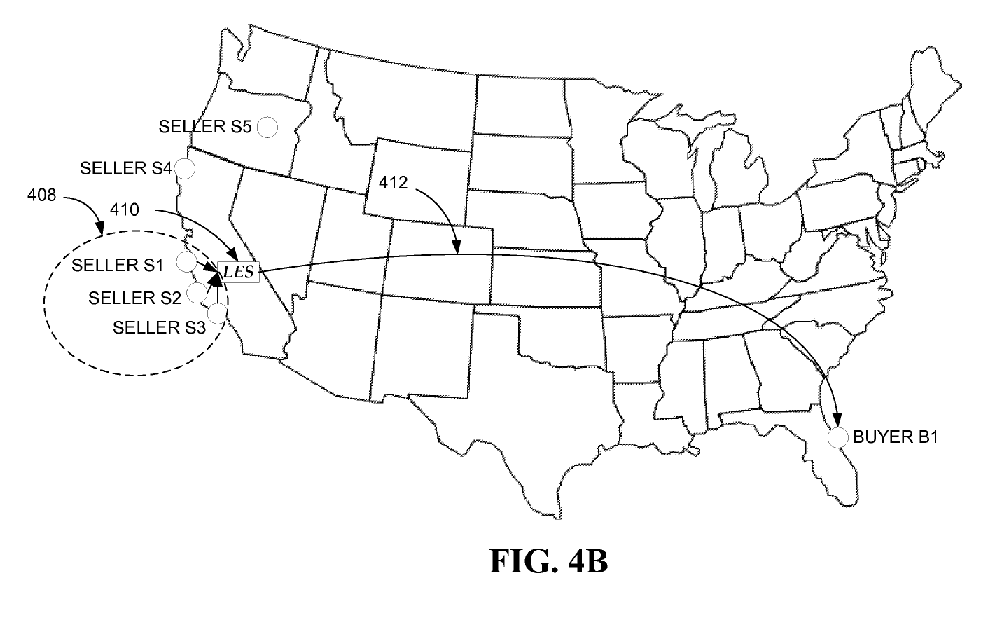

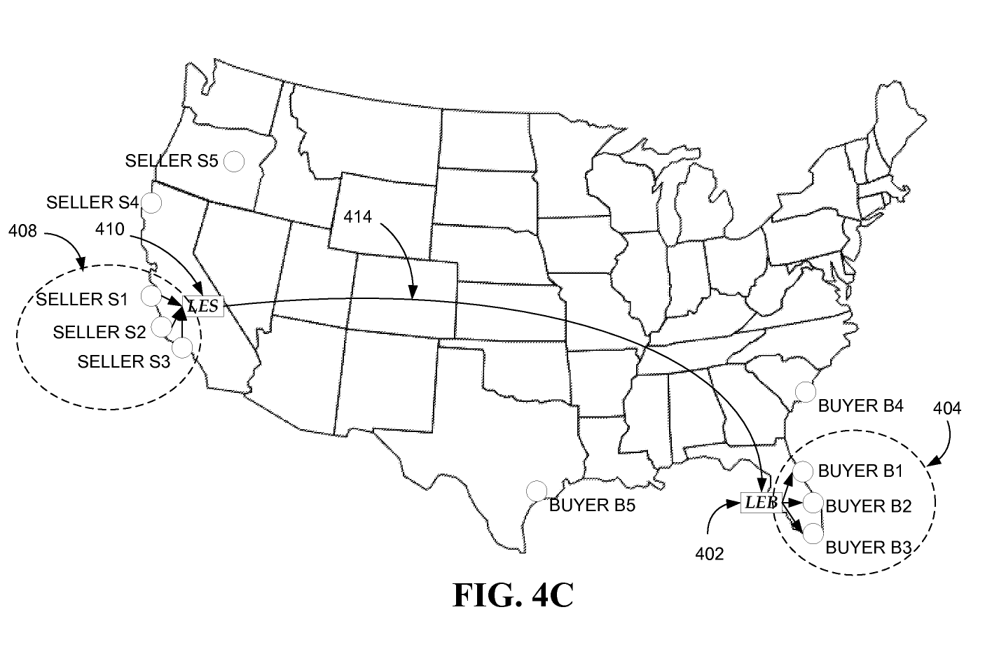

FIG. 4A shows a map diagram illustrating one example embodiment of a shipment using the shipping alliance application 122. The shipping alliance application 122 (e.g., the transaction access module 304) accesses orders from buyers B1, B2, B3, B4, and B5, and the local buyers identifier module 304 determines that buyers B1, B2, and B3 are in local proximity to one another (e.g., same zip code, same city, same county) and forms a local buyer group 404. The shipping alliance application 122 (e.g., local entity buyers module 310) determines whether an LEB 402 is already associated with local buyer group 404 made up of buyers B1, B2, B3. If there is no existing LEB associated with the local buyer group 404, the shipping alliance application 122 (e.g., local entity buyers module 310) forms a new LEB for local buyer group 404. The shipping alliance application 122 (e.g., shipping alliance processing module 314) instructs the seller S1 to combine all items ordered from B1, B2, and B3 and ship them in a single shipment 406 to LEB 402. Once the shipment arrives at LEB 402 associated with the buyers B1, B2, and B3, each item is removed from the shipment and shipped out individually over the “last mile” to the buyer location. For example, the item may be delivered using a local courier between the LEB 402 and the corresponding buyer delivery addresses.

FIG. 4B shows a map diagram illustrating another example embodiment of a shipment using the shipping alliance application 122. The shipping alliance application 122 (e.g., the transaction access module 304 accesses orders from buyer B1, and the local sellers identifier module 306 determines that buyer B1 has placed orders for items from sellers S1, S2, S3, S4, and S5. The shipping alliance application 122 determines that sellers S1, S2, and S3 are in local proximity to one another (e.g., same zip code, same city, same county) and forms a local seller group 408. The shipping alliance application 122 (e.g., local entity sellers module 312) determines whether a LES 410 is already associated with the local seller group 408 made up of sellers S1, S2, S3. If there is no existing LEB associated with local seller group 410, the shipping alliance application 122 (e.g., local entity sellers module 312) forms a new LEB for local seller group 410. The shipping alliance application 122 (e.g., shipping alliance processing module 314) instructs sellers S1, S2, and S3 to ship their items ordered from the same buyer B1 to their corresponding items to the LES 410. For example, the items may be dropped off or picked up using a local courier between the sellers S1, S2, S3 and LES 410. Once the shipments arrives at LES 410 associated with the sellers S1, S2, and S3, the items are bundled and shipped in one shipment 412 to the buyer B1.

FIG. 4C shows a map diagram illustrating one example embodiment of a shipment using the shipping alliance application 122. The shipping alliance application 122 accesses orders from buyer alliance (or buyer group 404) made up of buyers B1, B2, B3 and determines that buyer alliance 404 has placed orders for items from seller alliance (or seller group 408) made up of sellers S1, S2, S3. The shipping alliance application 122 instructs sellers S1, S2, and S3 to ship their items to LES 410. The LES 410 is to ship the items in one shipment 414 to LEB 402. The LEB 402 then distributes items corresponding to buyers B1, B2, and B3 in buyer group 404.

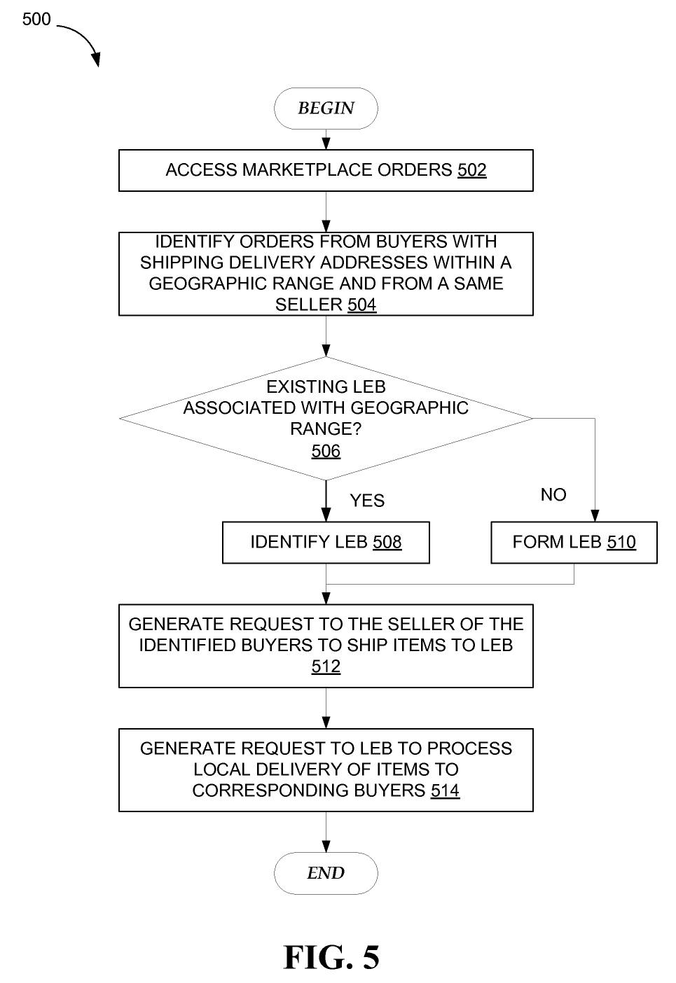

FIG. 5 shows a flow diagram illustrating one example embodiment of a method 500 performed by the shipping alliance application 122. At operation 502, the shipping alliance application 122 accesses unfulfilled or pending orders from the marketplace application 120. In one example embodiment, operation 502 may be implemented using the transaction access module 302.

At operation 504, the shipping alliance application 122 identifies orders from buyers with shipping delivery addresses within a geographic range or boundary and from a same seller. In one example embodiment, operation 504 may be implemented using the local buyers identifier module 304.

At operation 506, the shipping alliance application 122 determines whether an existing LEB is associated with the buyers in the geographic range. In one example embodiment, operation 506 may be implemented using the local entity buyers module 310.

At operation 508, the shipping alliance application 122 identifies an existing LEB, otherwise the shipping alliance application 122 forms a new LEB at operation 510. In one example embodiment, operation 508 and 510 may be implemented using the local entity buyers module 310.

At operation 512, the shipping alliance application 122 generates a request to the seller of the identified buyers to ship the items in a single shipment to the LEB. In one example embodiment, operation 512 may be implemented using the shipping alliance processing module 314.

At operation 514, the shipping alliance application 122 generates a request to the LEB to process local delivery of the items to the corresponding buyers. In one example embodiment, operation 514 may be implemented using the shipping alliance processing module 314.

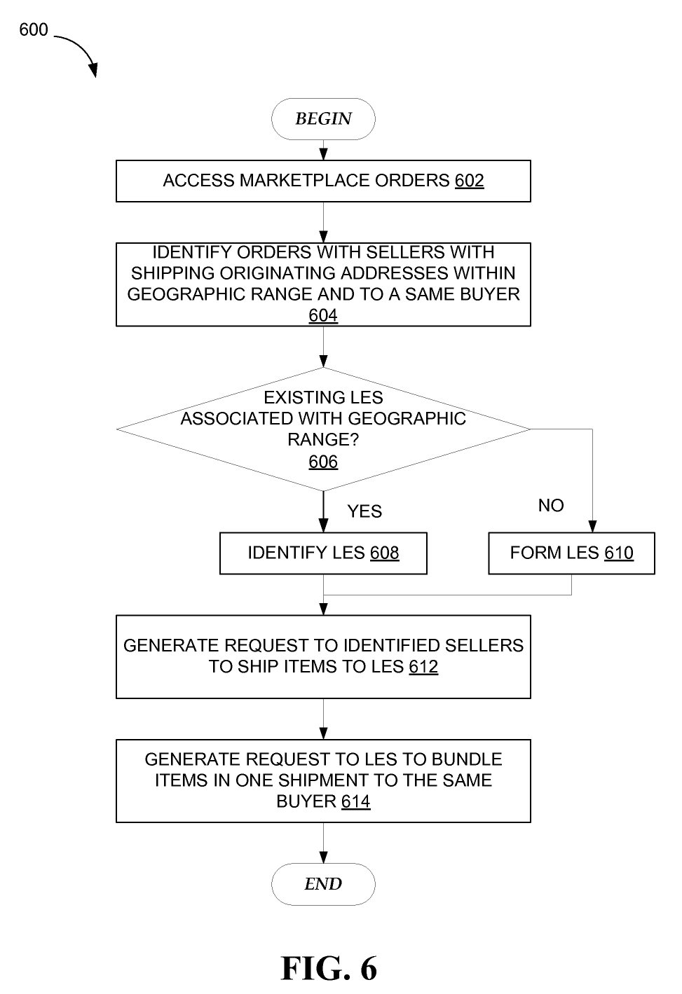

FIG. 6 shows a flow diagram illustrating one example embodiment of a method 600 performed by the shipping alliance application 122. At operation 602, the shipping alliance application 122 accesses unfulfilled or pending orders from the marketplace application 120. In one example embodiment, operation 602 may be implemented using the transaction access module 302.

At operation 604, the shipping alliance application 122 identifies orders with sellers with shipping originating addresses within a geographic range or boundary and to a same buyer. In one example embodiment, operation 604 may be implemented using the local sellers identifier module 306.

At operation 606, the shipping alliance application 122 determines whether an existing LES is associated with the sellers in the geographic range. In one example embodiment, operation 606 may be implemented using the local entity sellers module 312.

At operation 608, the shipping alliance application 122 identifies an existing LES, otherwise the shipping alliance application 122 forms a new LES at operation 610. In one example embodiment, operation 508 and 510 may be implemented using the local entity sellers module 312.

At operation 612, the shipping alliance application 122 generates a request to the sellers to ship the items to the LES. In one example embodiment, operation 612 may be implemented using the shipping alliance processing module 314.

At operation 614, the shipping alliance application 122 generates a request to the LES to bundle the items into one shipment to the same buyer. In one example embodiment, operation 614 may be implemented using the shipping alliance processing module 314.

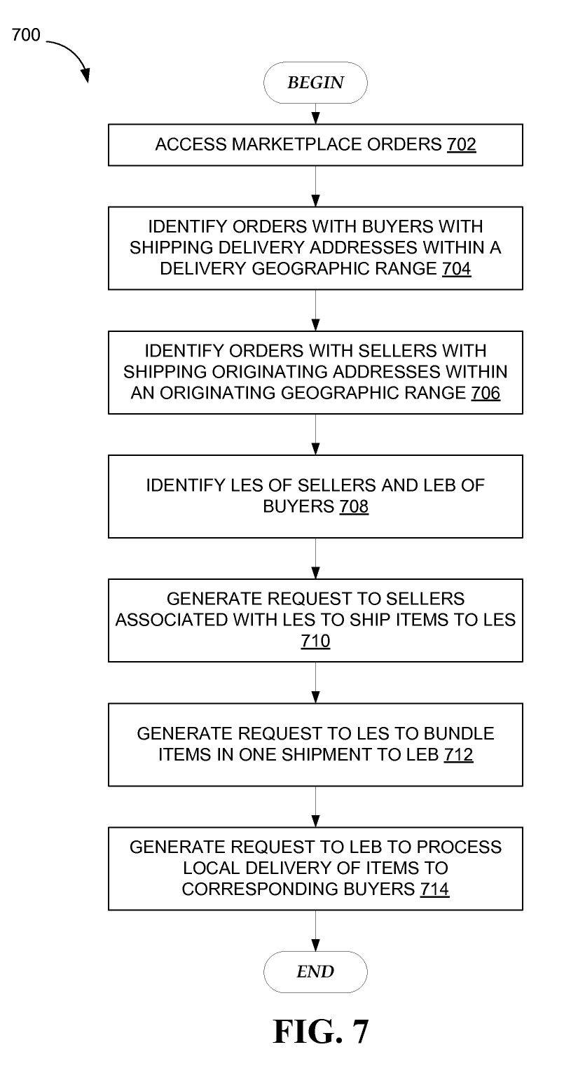

FIG. 7 shows a flow diagram illustrating a further example embodiment of a method 700 performed by the shipping alliance application 122. At operation 702, the shipping alliance application 122 accesses unfulfilled or pending orders from the marketplace application 120. In one example embodiment, operation 702 may be implemented using the transaction access module 302.

At operation 704, the shipping alliance application 122 identifies orders from buyers with shipping delivery addresses within a geographic range or boundary. In one example embodiment, operation 504 may be implemented using the local buyers identifier module 304.

At operation 706, the shipping alliance application 122 identifies orders with sellers with shipping originating addresses within a geographic range or boundary. In one example embodiment, operation 706 may be implemented using the local sellers identifier module 306.

At operation 708, the shipping alliance application 122 identifies existing LES and LEB, or forms a new LES or LEB. In one example embodiment, operation 708 may be implemented using the local entity buyers module 310 or the local entity sellers module 312.

At operation 710, the shipping alliance application 122 generates a request to the sellers to ship their items to the LES. In one example embodiment, operation 710 may be implemented using the shipping alliance processing module 314.

At operation 712, the shipping alliance application 122 generates a request to the LES to bundle the items into one shipment to the LEB. In one example embodiment, operation 712 may be implemented using the shipping alliance processing module 314.

At operation 714, the shipping alliance application 122 generates a request to the LEB to process local delivery of the items to the corresponding buyers. In one example embodiment, operation 714 may be implemented using the shipping alliance processing module 314.

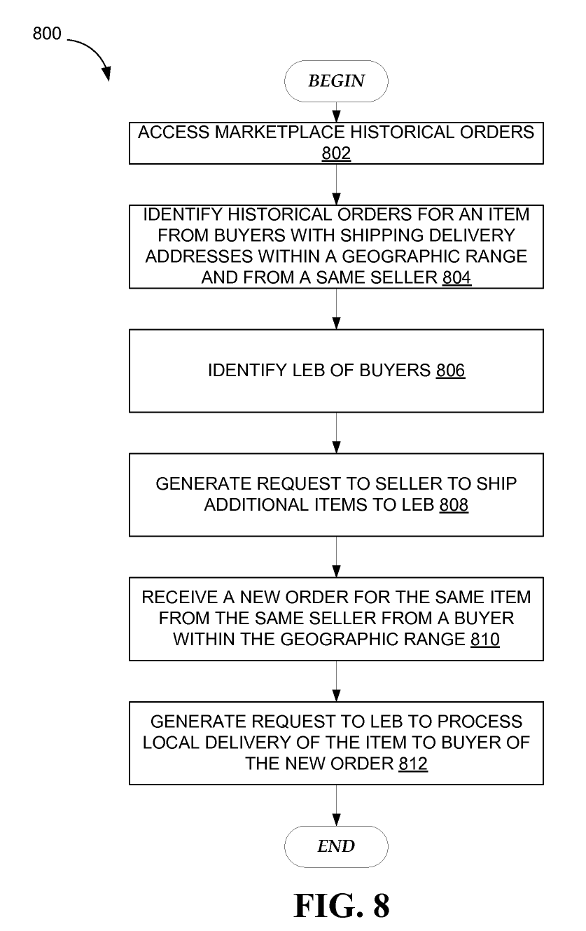

FIG. 8 shows a flow diagram illustrating another example embodiment of a method 800 performed by the shipping alliance application 122. At operation 802, the shipping alliance application 122 accesses historical orders from the marketplace application 120. In one example embodiment, operation 802 may be implemented using the transaction access module 302.

At operation 804, the shipping alliance application 122 identifies historical orders for one or more items from buyers with shipping delivery addresses within a geographic range or boundary and from a same seller. In one example embodiment, operation 804 may be implemented using the local buyers identifier module 304.

At operation 806, the shipping alliance application 122 determines an LEB of the buyers with shipping delivery addresses within a geographic range or boundary and from a same seller. In one example embodiment, operation 806 may be implemented using the local entity buyers module 310.

At operation 808, the shipping alliance application 122 generates a request to the seller to ship additional items (extra items to the orders) in a single shipment to the LEB. In example embodiments, the additional (extra) items comprise items that are predicted to be order by buyers in the LEB. In one example embodiment, operation 808 may be implemented using the shipping alliance processing module 314.

At operation 810, the marketplace application 120 receives a new order for one of the additional items from the same seller from a buyer within the geographic range. At operation 812, the shipping alliance application 122 generates a request to the LEB to process delivery of the previously shipped item (extra item) to the buyer of the new order.

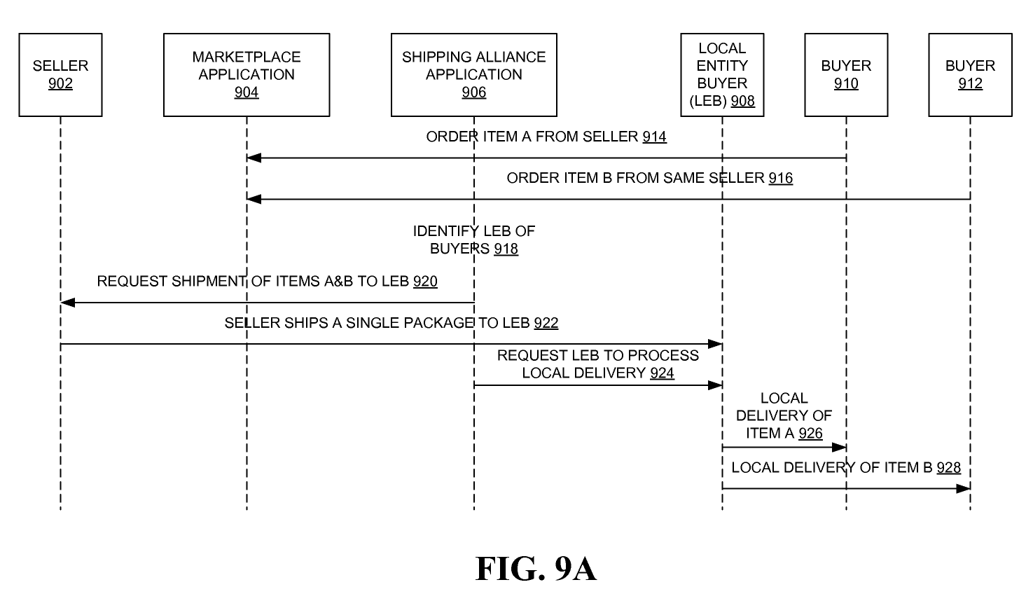

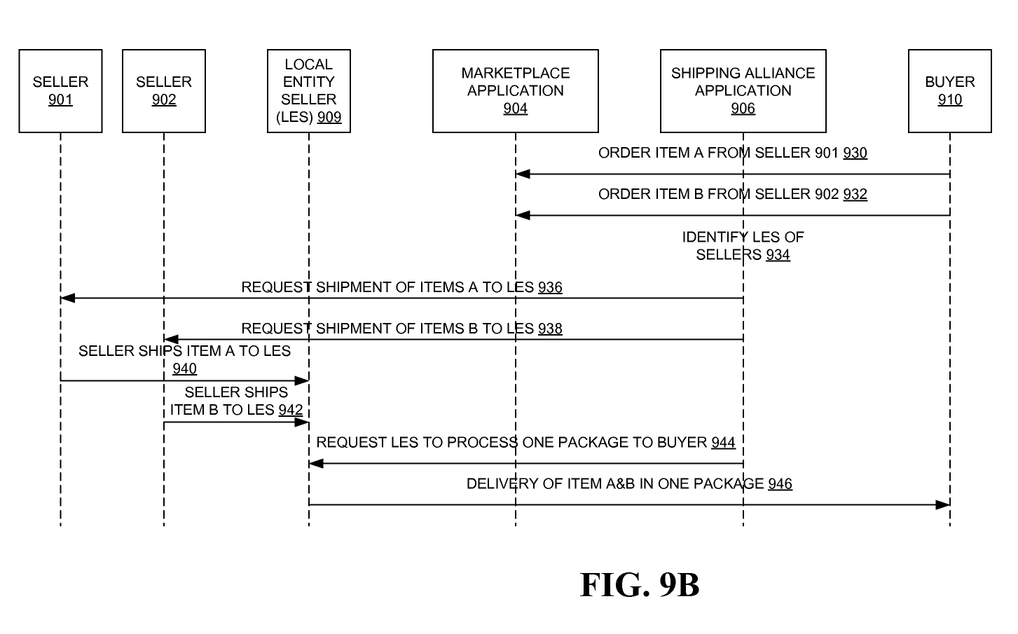

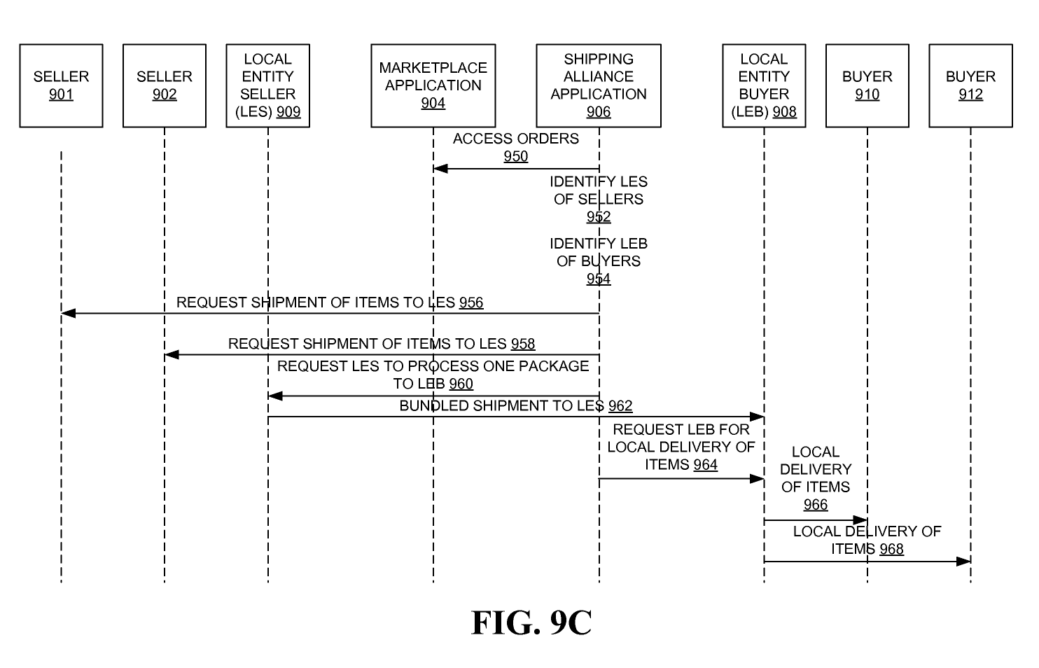

FIG. 9A shows an interaction diagram illustrating one example embodiment of an operation of a shipping alliance application for multiple buyers in local proximity to each other. At operation 914, a buyer 910 places an order for item A from seller 902 with an application marketplace 904. At operation 916, a buyer 912 places an order from item B from the same seller 902 with the application marketplace 904. At operation 918, the shipping alliance application 906 identifies an LEB 908 associated with buyers 910, 912. At operation 920, the shipping alliance application 906 generates a request to the seller 902 to ship items A and B together in one shipment to the LEB 908 of buyers 910, 912. At operation 922, the seller 902 ships a single package to the LEB 908. At operation 924, the shipping alliance application 906 generates a request to the LEB to process the local delivery of items A and B to respective buyers 910, 912. At operation 926, item A is delivered from LEB to buyer 910. At operation 928, item B is delivered from LEB to buyer 912.

FIG. 9B shows an interaction diagram illustrating another example embodiment of an operation of a shipping alliance application multiple sellers in local proximity to each other. At operations 930 and 932, the buyer 910 places an order for item A from seller 901 and for item B from seller 902 with the application marketplace 904. At operation 934, the shipping alliance application 906 identifies an LES 909 of the sellers 901, 902. At operation 936, the shipping alliance application 906 generates a request to the seller 901 to ship item A to LES 909. At operation 938, the shipping alliance application 906 generates a request to the seller 902 to ship item B to LES 909. At operation 940, seller 901 ships item A to LES 909. At operation 942, seller 902 ships item B to LES 909. At operation 944, the shipping alliance application 906 generates a request to LES 909 to process and bundle items A and B into one package or shipment to be delivered to buyer 910. At operation 946, items A and B are shipped in one shipment from the LES 909 to buyer 910.

FIG. 9C shows an interaction diagram illustrating a further example embodiment of an operation of a shipping alliance application for multiple sellers in local proximity to each other and for multiple buyers in local proximity to each other. At operation 950, shipping alliance application 906 accesses orders from the marketplace application 904. At operation 952, the shipping alliance application 906 identifies LES of sellers based on the orders. At operation 954, the shipping alliance application 906 identifies LEB of buyers based on the orders. At operation 956, the shipping alliance application 906 generates a request for seller 901 to ship ordered items to LES 909. At operation 958, the shipping alliance application 906 generates a request for seller 902 to ship ordered items to LES 909. At operation 960, the shipping alliance application 906 generates a request to LES 909 to process and bundle items received from sellers 901, 902 into one shipment to LEB 908. At operation 962, LES 909 ships the one shipment to LEB 908. At operation 964, the shipping application 906 generates a request to LEB 908 to process the local delivery of items to the respective buyers 910, 912. At operation 966, an item from the single shipment is delivered from LEB 908 to buyer 910. At operation 968, an item from the single shipment is delivered from LEB 908 to buyer 912.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### Example Computer System

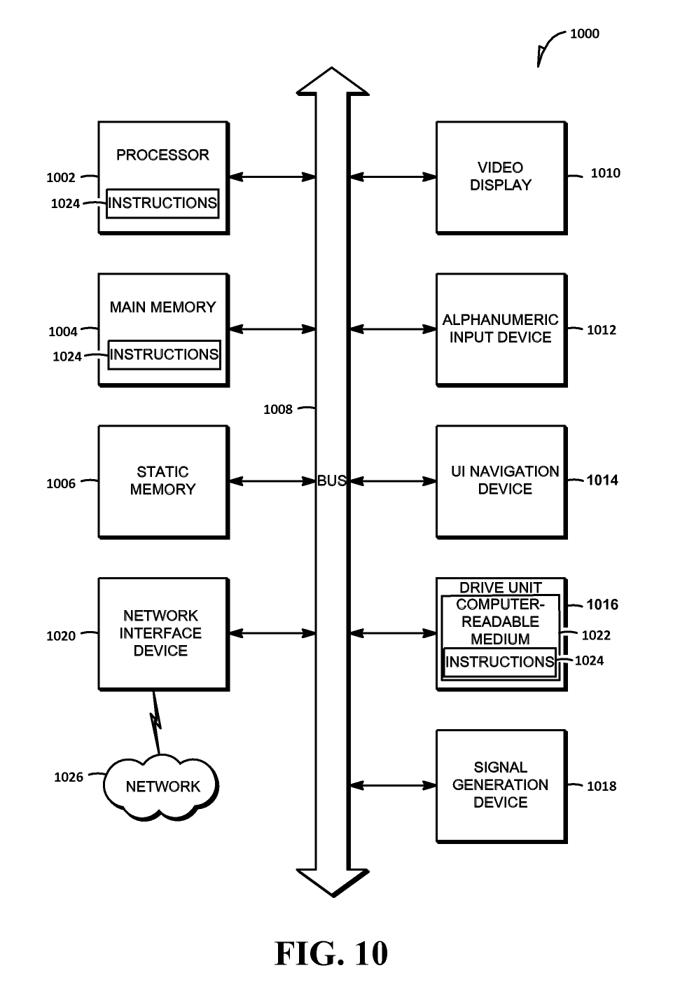

FIG. 10 shows a diagrammatic representation of a machine in the example form of a computer system 1000 within which a set of instructions 1024 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1024 (sequential or otherwise) that specify actions to be taken by that machine. Further, while only a single machine is illustrated, the term “machine” shall also be taken to include any collection of machines that individually or jointly execute a set (or multiple sets) of instructions 1024 to perform any one or more of the methodologies discussed herein.

The example computer system 1000 includes a processor 1002 (e.g., a central processing unit (CPU), a graphics processing unit (GPU, or both)), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a UI navigation device 1014 (e.g., a mouse), a disk drive unit 1016, a signal generation device 1018 (e.g., a speaker), and a network interface device 1020.

The drive unit 1016 includes a computer-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 or within the processor 1002 during execution thereof by the computer system 1000, with the main memory 1004 and the processor 1002 also constituting machine-readable media.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

While the computer-readable medium 1022 is shown in an example embodiment to be a single medium, the term “computer-readable medium” should be taken to include a single medium or multiple media (e.g., a centralized or distributed database, and/or associated caches and servers) that store the one or more sets of instructions 1024. The term “computer-readable medium” shall also be taken to include any medium that is capable of storing, encoding, or carrying a set of instructions 1024 for execution by the machine and that cause the machine to perform any one or more of the methodologies of the present disclosure, or that is capable of storing, encoding or carrying data structures utilized by or associated with such a set of instructions 1024. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
a transaction access module configured to access a plurality of unfulfilled orders from an online marketplace application; and
a shipping alliance module, comprising a hardware processor, configured to:
identify a group of buyers based on unfulfilled orders of buyers within a buyer predefined distance of each other, and a group of sellers based on unfulfilled orders of sellers within a seller predefined distance of each other,
identify a buyer local entity associated with the group of buyers, and a seller local entity associated with the group of sellers, and
generate a request to a common seller of the group buyers to combine items from the unfulfilled orders into a single flat fee shipment to the buyer local entity, and a request to the group of buyers to ship items from the unfulfilled orders to the seller local entity.

2. The system of claim 1, wherein the buyer local entity includes a third party, a buyer from the group of buyers, or a shipping carrier.

3. The system of claim 1, wherein the seller local entity includes a third party, a seller from the group of sellers, or a shipping carrier.

4. The system of claim 1, wherein the buyers from the group of buyers have a corresponding shipping delivery address in proximity of each other.

5. The system of claim 1, wherein the sellers from the group of sellers have a corresponding shipping originating address in proximity of each other.

6. The system of claim 1, further comprising:
forming a new buyer local entity associated with the group of buyers in response to determining that the group of buyers is not associated with any buyer local entity.

7. The system of claim 1, further comprising:
forming a new seller local entity associated with the group of sellers in response to determining that the group of sellers is not associated with any seller local entity.

8. The system of claim 1, further comprising:
generating a local delivery request to the buyer local entity to deliver items from the unfulfilled orders to the corresponding buyers associated with the buyer local entity.

9. The system of claim 1, further comprising:
computing a shipping delivery fee for each buyer based on a fee associated with the single flat fee shipment.

10. The system of claim 1, further comprising a predictive module configured to:
access historical orders data from the online marketplace,
identify historical orders for an item from a second group of buyers having shipping delivery addresses within a geographic range and from a second seller,
identify a buyer local entity associated with the second group of buyers, and
generate a request to the second seller to ship additional items to the buyer local entity based on the historical orders for the item.

11. A method comprising:
accessing orders from an online marketplace application;
identifying a group of buyers based on unfulfilled orders of buyers within a buyer predefined distance of each other, and a group of sellers based on unfulfilled orders of sellers within a seller predefined distance of each other;
identifying a buyer local entity associated with the group of buyers, and a seller local entity associated with the group of sellers; and
generating, by a hardware processor, a request to a common seller of the group buyers to combine items from the unfulfilled orders into a single flat fee shipment to the buyer local entity, and a request to group of buyers to ship items from the unfulfilled orders to the seller local entity.

12. The method of claim 11, wherein the buyer local entity includes a third party, a buyer from the group of buyers, or a shipping carrier.

13. The method of claim 11, wherein the seller local entity includes a third party, a seller from the group of sellers, or a shipping carrier.

14. The method of claim 11, wherein the buyers from the group of buyers have a corresponding shipping delivery address in proximity of each other.

15. The method of claim 11, wherein the sellers from the group of sellers have a corresponding shipping originating address in proximity of each other.

16. The method of claim 11, further comprising:
forming a new buyer local entity associated with the group of buyers in response to determining that the group of buyers is not associated with any buyer local entity; and
forming a new seller local entity associated with the group of sellers in response to determining that the group of sellers is not associated with any seller local entity.

17. The method of claim 11, further comprising:
generating a local delivery request to the buyer local entity to deliver items from the unfulfilled orders to the corresponding buyers associated with the buyer local entity.

18. The method of claim 11, further comprising:
computing a shipping delivery fee for each buyer based on a fee associated with the single flat fee shipment.

19. The method of claim 11, further comprising:
accessing historical orders data from the online marketplace application;
identifying historical orders for an item from a second group of buyers with shipping delivery addresses within a geographic range and from a second seller;
identifying a buyer local entity associated with the second group of buyers; and
generating a request to the second seller to ship additional items to the buyer local entity based on the historical orders for the item.

20. A non-transitory computer-readable storage medium storing a set of instructions that, when executed by a processor of a machine, cause the machine to perform operations, comprising:
accessing orders from an online marketplace application;
identifying a group of buyers based on unfulfilled orders of buyers within a buyer predefined distance of each other, and a group of sellers based on unfulfilled orders of sellers within a seller predefined distance of each other;
identifying a buyer local entity associated with the group of buyers, and a seller local entity associated with the group of sellers; and
generating a request to a common seller of the group buyers to combine items from the unfulfilled orders into a single flat fee shipment to the buyer local entity, and a request to group of buyers to ship items from the unfulfilled orders to the seller local entity.
